(19) United States
(12) Patent Application Publication
(10) Pub. No.: US 2020/0049595 A1
(43) Pub. Date: Feb. 13, 2020

(54) PIPE DIAGNOSIS APPARATUS, ASSET MANAGEMENT APPARATUS, PIPE DIAGNOSIS METHOD, AND COMPUTER-READABLE RECORDING MEDIUM

(71) Applicant: NEC Corporation, Minato-ku, Tokyo (JP)

(72) Inventors: Jun SAKAI, Tokyo (JP); Takahiro KUMURA, Tokyo (JP); Manabu KUSUMOTO, Tokyo (JP); Soichiro TAKATA, Tokyo (JP)

(73) Assignee: NEC Corporation, Minato-ku, Tokyo (JP)

(21) Appl. No.: 16/497,011

(22) PCT Filed: Jan. 23, 2018
(86) PCT No.: PCT/JP2018/001922

§ 371 Date: Sep. 24, 2019

(30) Foreign Application Priority Data
Mar. 28, 2017 (JP) 2017-062649

(51) Int. Cl. G01M 99/00; G01N 3/06; F17D 5/02

(52) U.S. Cl. CPC G01M 99/00; F17D 5/02; G01N 3/064

(57) ABSTRACT

A pipe diagnosis apparatus 10 includes a time-series data acquisition unit 11 that acquires time-series data on pressure of a fluid in piping equipment to be diagnosed, a pressure change measurement unit 12 that measures the number of pressure changes in the fluid from the time-series data on the pressure of the fluid, and a failure risk estimation unit 13 that estimates a failure risk of the piping equipment based on the measured number of pressure changes and a strength of a pipe included in the piping equipment.

### TECHNICAL FIELD

The present invention relates to a pipe diagnosis apparatus and a pipe diagnosis method for diagnosing a failure risk of piping equipment such as water supply equipment, and further relates to a computer-readable recording medium in which programs for realizing the apparatus and method are stored, and an asset management apparatus in which the pipe diagnosis apparatus is used.

### BACKGROUND ART

The scale of piping equipment such as water supply pipe networks are often incredibly large. In addition, progression of deterioration of a pipe buried under ground may differ according to the acidity, potential, pressure, and the like of the soil in which the pipe is buried. Therefore, there are cases where a relatively new pipe deteriorates rapidly and needs to be replaced at an early stage. Thus, there is demand for techniques for appropriately diagnosing the current degree of deterioration of a pipe and future progression of the deterioration so as to enable accurate and efficient repairing and replacement of the pipe.

Regarding a technique for diagnosing the current degree of deterioration of a pipe, Patent Document 1 discloses a technique related to non-destructive inspection of a pipe. In the technique disclosed in Patent Document 1, first, an actual measurement value indicating the propagation speed of vibrations that propagate along a pipe through two points that are spaced apart in the longitudinal direction of the pipe is acquired. Subsequently, the thickness of the pipe is back-calculated by adapting the actual measurement value to an equation for obtaining the thickness of a pipe from the value of propagation speed.

Then, in the technique disclosed in Patent Document 1, the current degree of deterioration of the pipe is determined based on the calculated thickness of the pipe, and progression of the deterioration of the pipe is diagnosed.

### LIST OF RELATED ART DOCUMENTS

### Patent Document

Patent document 1: Japanese Patent Laid-Open Publication No. 2013-61350

### SUMMARY OF INVENTION

### Problems to be Solved by the Invention

However, in the technique disclosed in Patent document 1 above, it is impossible to estimate the future progression speed of deterioration of a water pipe and the lifespan of the water pipe based thereon. Therefore, an appropriate time to replace the pipe cannot be estimated, and a problem arises in that water supply businesses cannot determine economically efficient replacement priorities for a large number of pipes owned by them.

An example object of the invention is to provide a pipe diagnosis apparatus, an asset management apparatus, a pipe diagnosis method, and a computer-readable recording medium that enable estimation of future progression of deterioration of pipes in piping equipment, in light of the above-described issues.

### Means for Solving the Problems

In order to achieve the aforementioned object, a pipe diagnosis apparatus according to an example aspect of the invention includes:

a time-series data acquisition unit configured to acquire time-series data on pressure of a fluid in piping equipment to be diagnosed;

a pressure change measurement unit configured to measure the number of pressure changes in the fluid from the time-series data on the pressure of the fluid; and

a failure risk estimation unit configured to estimate a failure risk of the piping equipment based on the measured number of pressure changes and a strength of a pipe included in the piping equipment.

In order to achieve the aforementioned object, an asset management apparatus according to an example aspect of the invention includes:

a time-series data acquisition unit configured to acquire time-series data on pressure of a fluid in piping equipment to be diagnosed;

a pressure change measurement unit configured to measure the number of pressure changes in the fluid from the time-series data on the pressure of the fluid;

a failure risk estimation unit configured to estimate a failure risk of the piping equipment based on the measured number of pressure changes and a strength of a pipe included in the piping equipment; and

a replacement priority setting unit configured to set a replacement priority of each pipe included in the piping equipment, based on the failure risk estimated by the failure risk estimation unit.

In addition, in order to achieve the aforementioned object, a pipe diagnosis method according to an example aspect of the invention includes:

(a) a step of acquiring time-series data on pressure of a fluid in piping equipment to be diagnosed;

(b) a step of measuring the number of pressure changes in the fluid from the time-series data on the pressure of the fluid; and

(c) a step of estimating a failure risk of the piping equipment based on the measured number of pressure changes and a strength of a pipe included in the piping equipment.

Furthermore, in order to achieve the aforementioned object, a computer-readable recording medium according to an example aspect of the invention causes a computer to execute:

(a) a step of acquiring time-series data on pressure of a fluid in piping equipment to be diagnosed;

(b) a step of measuring the number of pressure changes in the fluid from the time-series data on the pressure of the fluid; and

(c) a step of estimating a failure risk of the piping equipment based on the measured number of pressure changes and a strength of a pipe included in the piping equipment.

### Advantageous Effects of the Invention

As described above, according to the invention, it is possible to estimate future progression of deterioration of a pipe in piping equipment.

### BRIEF DESCRIPTION OF THE DRAWINGS

FIG. 1 is a block diagram illustrating a schematic configuration of a pipe diagnosis apparatus in an example embodiment of the invention.

FIG. 2 is a block diagram illustrating a specific configuration of the pipe diagnosis apparatus in the example embodiment of the invention.

FIG. 3 is an explanatory diagram illustrating pressure and stress that are applied to a pipe.

FIG. 4 is a diagram illustrating an example of an S-N curve of a pipe.

FIG. 5 is a flow chart illustrating operations of the pipe diagnosis apparatus in the example embodiment of the invention.

FIG. 6 is a diagram illustrating an example of time-series data on hydraulic pressure at a point within a water distribution block.

FIG. 7 is a block diagram illustrating a configuration of an asset management apparatus in an example embodiment of the invention.

FIG. 8 is a block diagram illustrating an example of a computer that realizes the pipe diagnosis apparatus in the example embodiment of the invention.

### EXAMPLE EMBODIMENT

### Example Embodiment

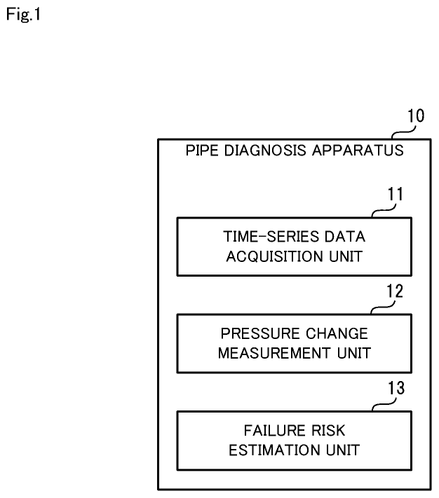

A pipe diagnosis apparatus, a pipe diagnosis method, and a computer-readable recording medium in an example embodiment of the invention will be described below with reference to FIGS. 1 to 8.

### [Apparatus Configuration]

First, the configuration of the pipe diagnosis apparatus in the present example embodiment will be described with reference to FIG. 1. FIG. 1 is a block diagram illustrating a schematic configuration of the pipe diagnosis apparatus in the example embodiment of the invention.

A pipe diagnosis apparatus 10 in the present example embodiment shown in FIG. 1 is an apparatus for diagnosing future deterioration of piping equipment to be diagnosed. As shown in FIG. 1, the pipe diagnosis apparatus 10 is provided with a time-series data acquisition unit 11, a pressure change measurement unit 12, and a failure risk estimation unit 13.

The time-series data acquisition unit 11 acquires time-series data on the pressure of a fluid in piping equipment to be diagnosed. The pressure change measurement unit 12 measures the number of times pressure changes in the fluid, based on the time-series data on the pressure of the fluid. The failure risk estimation unit 13 estimates a failure risk of piping equipment based on the measured number of pressure changes and the strength of pipes included in the piping equipment.

In this manner, in the present example embodiment, a failure risk of piping equipment to be diagnosed is estimated, and thus it is possible to estimate future progression of deterioration of pipes. Accordingly, it is also possible to determine appropriate replacement times and replacement order of pipes in the piping equipment.

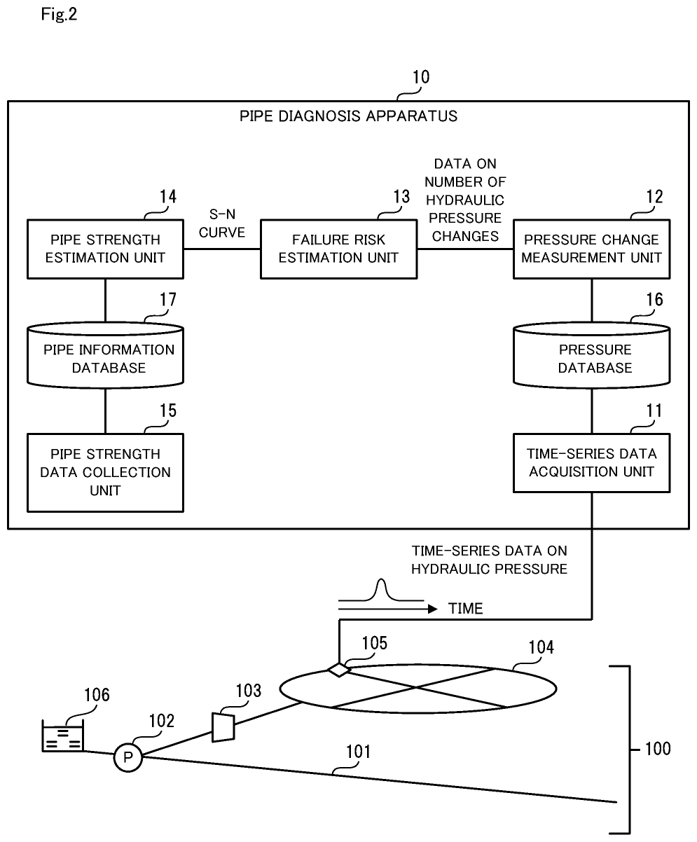

Subsequently, the configuration of the pipe diagnosis apparatus in the present example embodiment will be described in detail with reference to FIG. 2. FIG. 2 is a block diagram illustrating a specific configuration of the pipe diagnosis apparatus in the example embodiment of the invention.

First, the piping equipment to be diagnosed in the present example embodiment will be described. As illustrated in FIG. 2, in the present example embodiment, piping equipment 100 is a water pipe network that makes up a water-and-sewage system, and the fluid is water. The piping equipment 100 is provided with a water purification plant 106, a water main 101, and a water distribution block 104.

In addition, a pump 102 is installed between the water purification plant 106 and the water main 101, depending on the shape of the land on which the piping equipment 100 is installed. In this case, the pump 102 applies pressure so as to supply water to an end of the water distribution block 104, and thus water is discharged from the end.

Normally, the pump 102 delivers water under high pressure during the daytime due to an increase in water demand, and under low hydraulic pressure late at night due to a decrease in water demand. When switching the operation mode of this pump 102, a hydraulic pressure change of a large amplitude occurs, and pressure waves propagate to the water main 101. This propagation of a hydraulic pressure change is also called “water hammer”.

On the other hand, a pressure reducing valve 103 is installed at the inlet of the water distribution block 104 so that excessive hydraulic pressure does not act inside the water distribution block 104. If the hydraulic pressure on the water main 101 side, which is the input side, is higher than the hydraulic pressure on the water distribution block 104 side, which is the output side, the pressure reducing valve 103 adjusts the hydraulic pressure on the output side is constant. This pressure reducing valve 103 prevents water hammer of a large amplitude propagated through the water main 101 from propagating into the water distribution block 104, and a load on a water facility such as piping in the water distribution block 104 is suppressed.

However, even if the pressure reducing valve 103 can shield the water distribution block 104 from external water hammer, water hammer also occurs in the water distribution block 104 due to quick opening/closing of a valve, generation and collapse of an air bubble, quick opening/closing of a faucet when a consumer uses water, and the like. Such water hammer causes stress change in pipes, and fatigues the pipes.

This is because minute cracks occur in a pipe at the time of manufacturing and over long periods of use, the cracks grow every time the whole pipe expands and shrinks due to a stress change. Then, if stress changes occur repeatedly over long periods of use, fatigue progresses and the pipe breaks. Therefore, in order to estimate a time to replace each pipe of a water pipe network that makes up the water distribution block 104, it is important to evaluate not only the deterioration state of the pipes but also hydraulic pressure change that occurs in the pipes, and to estimate the speed of progression of deterioration.

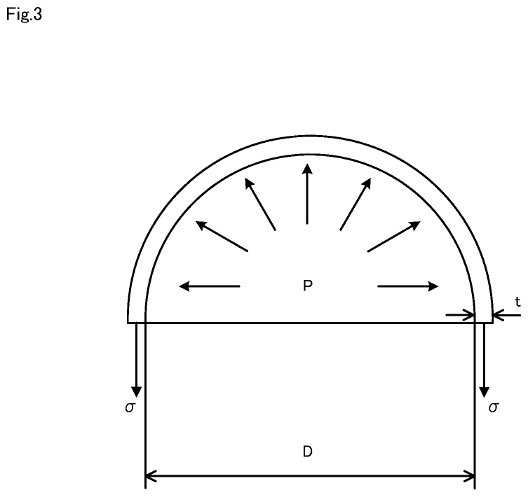

The relationship between such repetitive stress changes and fatigue breakdown will be described. FIG. 3 is an explanatory diagram illustrating pressure and stress that are applied to a pipe. In the example in FIG. 3, to facilitate description, only half of a cross section of a pipe is shown. First, as shown in FIG. 2, when pressure p is applied to a cylindrical pipe having a diameter d and a thickness t, stress σ acts so as to expand the pipe in its circumferential direction. This stress is called hoop stress, and is calculated based on Formula 1 below.

$$σ = \frac{pd}{2 t} \qquad [ Formula 1 ]$$

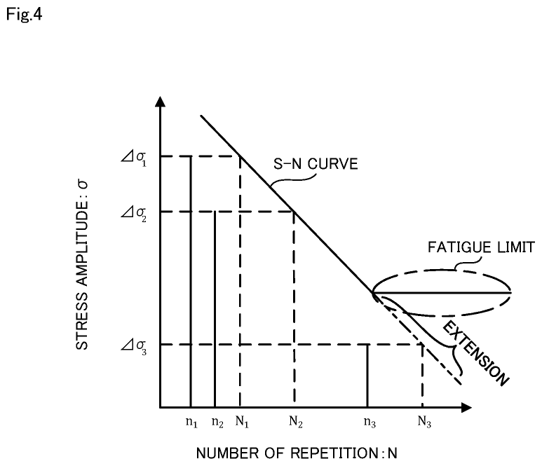

When a stress change of a certain amplitude Δσ occurs repeatedly in the pipe shown in FIG. 3, the pipe breaks at a certain number of times N. FIG. 4 is a diagram illustrating an example of an S-N curve of a pipe. Assume that, as shown in FIG. 4, a stress change of an amplitude Δσ₁ repeatedly occurs in the pipe, and the pipe breaks at the N₁th time. Similarly, assume that a stress change of an amplitude Δσ₂ repeatedly occurs in the pipe, and the pipe breaks at the N₂th time. In this case, the S-N curve shown in FIG. 4 is acquired as a strength characteristic of the pipe.

Regarding an ordinary steel material, in the case of an amplitude of a certain magnitude or smaller, a stress amplitude value that can be applied without causing fracturing even if the number of repetitions is increased does exist, and this is called a “fatigue limit”. The amplitude of a stress change due to a hydraulic pressure change is sufficiently smaller than the fatigue limit of the pipe, and has been conventionally considered to be ignorable.

In contrast, in the pipe diagnosis apparatus 10 in the present example embodiment, progress of deterioration due to a stress amplitude that is smaller than or equal to this fatigue limit is also taken into consideration, the inclination of the S-N curve is extended along a straight line to the fatigue limit or lower, and all of the stress amplitudes are accumulated as damage. In the example in FIG. 4, the number of times at a position at which a stress change amplitude Δσ₃ that is smaller than or equal to the fatigue limit intersects with the extended line of the S-N curve is N₃.

The above-described S-N curve is generated by fixing an amplitude of a stress change and conducting fatigue tests until a break occurs, but stress of various amplitudes is applied in a complex manner to an actual pipe, and thus it is necessary to perform comprehensive evaluation. Here, assume that, after a pipe has been manufactured and installed, a hoop stress change of an amplitude σ₁ occurs n₁ times, a hoop stress change of an amplitude σ₂ occurs n₂ times, and a hoop stress change of an amplitude σ₃ occurs n₃ times. The degree of fatigue D of the pipe at this time can be evaluated using Formula 2 below. A larger degree of fatigue D indicates a higher risk of breaking. The maximum value of the degree of fatigue D is 1.

$$D = \frac{{n}_{1}}{{N}_{1}} + \frac{{n}_{2}}{{N}_{2}} + \frac{{n}_{3}}{{N}_{3}} = \sum \frac{{n}_{i}}{{N}_{i}} \qquad [ Formula 2 ]$$

Next, the configuration of the pipe diagnosis apparatus in the present example embodiment will be described below in detail. As shown in FIG. 2, the pipe diagnosis apparatus 10 is provided with a pipe strength estimation unit 14, a pipe strength data collection unit 15, a pressure database 16, and a pipe information database 17, in addition to the time-series data acquisition unit 11, the pressure change measurement unit 12, and the failure risk estimation unit 13 that have been described above.

In the present example embodiment, the time-series data acquisition unit 11 acquires time-series data using data that is output by a pressure sensor 105 installed in a pipe included in the piping equipment 100. Specifically, the pressure sensor 105 is installed in a pipe in the water distribution block 104, and outputs data for specifying the pressure of water (hydraulic pressure) that flows through the pipe, at set intervals. In addition, in the example in FIG. 2, only a single pressure sensor 105 is illustrated, but in actuality, a plurality of pressure sensors 105 may be installed at respective portions of the water distribution block 104.

In addition, the pressure sensor 105 may also be installed in a telemeter near the pressure reducing valve 103 at the inlet of the water distribution block 104. Furthermore, the pressure sensor 105 may also be installed at any position in the water distribution block 104, for example, at a location of a fire hydrant or a pressure release valve. In order to appropriately measure hydraulic pressure changes that affect a pipe, it is desirable that the pressure sensor 105 measures hydraulic pressure at a frequency of 100 samples per second or more.

The time-series data acquisition unit 11 acquires time-series data on hydraulic pressure output by this pressure sensor 105, and stores the acquired time-series data in the pressure database 16. In addition, the pressure sensor 105 may also have a function of transmitting data in a wireless or wired manner. In that case, the time-series data acquisition unit 11 acquires time-series data by receiving data transmitted from the pressure sensor 105.

In addition, the pressure sensor 105 may also be a field-portable sensor provided with a data storage apparatus. In this case, the pressure sensor 105 is installed at any location in the water distribution block 104 for a few days, and, during this period of time, measures time-series data on hydraulic pressure, and stores the data. Then, the time-series data acquisition unit 11 acquires the time-series data on the hydraulic pressure from the data storage apparatus of the pressure sensor 105.

In addition, in the present example embodiment, the time-series data acquisition unit 11 can also acquire pressure estimated using a hydraulic simulator as time-series data, regarding all or some of the pipes included in the piping equipment 100. Accordingly, hydraulic pressure is directly measured at a location where the pressure sensor 105 is installed, and the measurement value is used directly, but pressure is not measured at a location where the pressure sensor 105 is not installed. At such a location where the pressure sensor 105 is not installed, the time-series data acquisition unit 11 can estimate hydraulic pressure using the time-series data measured in the same water distribution block 104 and the hydraulic simulator.

Specifically, in this case, the time-series data acquisition unit 11 generates a pipe network analysis model based on calibers, materials, distances, and connection information of target pipes of the water distribution block 104, inputs time-series data measured at installation locations of the pressure sensors 105 to the generated model, and executes analysis. Accordingly, time-series data on hydraulic pressure at each point in the water distribution block 104 is calculated. Examples of such a hydraulic simulator include EPANET and the like.

In the present example embodiment, the pressure change measurement unit 12 measures the number of hydraulic pressure changes, from the acquired time-series data on the hydraulic pressure, for each portion of the water distribution block 104. In addition, when measuring a change, the pressure change measurement unit 12 also measures the range of the amplitude at that time. Examples of a method for measuring a coefficient for hydraulic pressure change includes a rainflow counting method. The rainflow counting method conforms to a hysteresis curve of a material, and thus is suitable for fatigue lifespan estimation. In addition, it is also possible to use a peak count method, a level crossing count method, a mean crossing count method, a range count method, a range-pair count method, and the like.

The pipe strength data collection unit 15 collects strength data on a pipe that has been input from the outside, or deterioration data indicating the state of deterioration of a pipe. In addition, the strength data that is input may also be acquired by measuring the actual strength of a target pipe. Examples of a strength measurement method include a method for directly measuring a thickness, a magnetic flux leakage method (MFL method) for measuring strength using a magnetic field sensor, a remote field eddy current method (RFEC method) for measuring an excessive current, and a broadband electromagnetic method (BEM method). Note that, in order to carry out these methods, soil around a location in which the pipe is buried needs to be excavated in advance.

In addition, examples of a method for measuring the strength of a pipe without excavating soil in a state where the pipe is buried include a method for estimating a thickness from a sound speed, which is disclosed in Patent Document 1 above. In addition, a method in which a camera is inserted into a pipe, the surface of the pipe wall is observed, and the deterioration state of the pipe is roughly estimated is also included. The pipe strength data collection unit 15 stores strength data and deterioration data on a pipe that have been collected in this manner, to a pipe information database 17.

The pipe information database 17 may also store information for specifying the material, caliber, distance, time when the pipe was laid, place, and the like of each pipe, in addition to the strength data and the deterioration data. Furthermore, the pipe information database may also store data on an S-N curve indicating the strength of a pipe, based on experimental data or document information, for each material and caliber of the pipe. Regarding this S-N curve, both data on a new pipe and data on a deteriorated pipe are preferably stored, and, in this case, in particular, the S-N curve of the deteriorated pipe is stored in association with the degree of strength of the pipe corresponding thereto.

The pipe strength estimation unit 14 estimates the strength of each of the pipes that make up the piping equipment 100. Specifically, the pipe strength estimation unit 14 estimates the strength of a target pipe based on information stored in the pipe information database 17, and outputs an S-N curve.

Specifically, regarding a pipe whose strength has been directly measured, the pipe strength estimation unit 14 selects or generates an S-N curve corresponding to the measurement result. In addition, regarding a pipe whose strength has not been measured directly, the pipe strength estimation unit 14 generates an S-N curve of the target pipe, from the pipe information database 17, based on an S-N curve of a pipe whose material and caliber are the same as those of the target pipe.

Furthermore, if an S-N curve of a pipe having the same material and caliber as the target pipe is not stored in the pipe information database 17, the pipe strength estimation unit 14 calculates an S-N curve of the target pipe from the S-N curve of a pipe having the same material but a different caliber.

In addition, if the strength of the target pipe has not been measured, the pipe strength estimation unit 14 can estimate the degree of deterioration based on the number of years that have elapsed since the target pipe was laid and the average lifespan of a pipe, and generate an S-N curve of the target pipe based on the estimated degree of deterioration.

In the present example embodiment, the failure risk estimation unit 13 calculates, as a failure risk, an index whose value increases as the number of pressure changes increases. Note that a failure risk is not limited to this example, and an index whose value increases as the amplitude of pressure change increases may also be calculated as a failure risk.

Specifically, the failure risk estimation unit 13 calculates an index indicating a failure risk for each target pipe, using the number of hydraulic pressure changes measured by the pressure change measurement unit 12 and the S-N curve of the target pipe estimated by the pipe strength estimation unit 14. The failure risk estimation unit 13 can use one or more indexes as an index of a failure risk, according to the type of data acquired for calculation.

For example, if the cumulative number of hydraulic pressure changes n₁, n₂, and n₃ from when a pipe was laid has been acquired, the failure risk estimation unit 13 can calculate the degree of fatigue D using Formula 2 above, and outputs the calculated degree of fatigue D as a failure risk of the pipe.

In addition, if D=1 in Formula 2 above, an estimated time when a pipe will break is statistically indicated, and thus the failure risk estimation unit 13 can estimate the remaining lifespan of the pipe using this. Specifically, assuming that, when the current degree of fatigue is D and the present time is a time Δt, hoop stress changes of amplitudes σ₁, σ₂, σ₃, . . . , σᵢ respectively occur Δn₁, Δnₑ, Δn₃, . . . , Δnᵢth times, the failure risk estimation unit 13 first calculates an increase rate ΔD/Δt of the degree of fatigue per unit of time using Formula 3 below.

$$\frac{Δ D}{Δ t} = ( \frac{Δ {n}_{1}}{{N}_{1}} + \frac{Δ {n}_{2}}{{N}_{2}} + \frac{Δ {n}_{3}}{{N}_{3}} ) \frac{1}{Δ t} = \frac{1}{Δ t} \sum \frac{Δ {n}_{i}}{{N}_{i}} \qquad [ Formula 3 ]$$

Then, in Formula 3 above, a period of time (remaining lifespan) t′ until D=1 is D+t′ ΔD/Δt=1, and thus the failure risk estimation unit 13 calculates the length of the time period (remaining lifespan) t′, using Formula 4 below.

$${t}^{′} = \frac{Δ t ( 1 - D )}{\sum \frac{Δ {n}_{i}}{{N}_{i}}} \qquad [ Formula 4 ]$$

In addition, even if the cumulative number of hydraulic pressure changes from when a pipe was laid cannot be acquired, the failure risk estimation unit 13 can estimate the current degree of fatigue by multiplying the increase rate ΔD/Δt of the degree of fatigue acquired from the number of hydraulic pressure changes that has been observed, by the length of time that has elapsed from when the pipe was laid. In addition, even if the cumulative number of hydraulic pressure changes from when the pipe was laid cannot be acquired, if the current strength data can be acquired, the failure risk estimation unit 13 estimates the degree of fatigue D from the current strength data. In this case, the failure risk estimation unit 13 further estimates a failure risk from the estimated degree of fatigue D.

As described above, in the present example embodiment, one of the degree of fatigue D, the increase rate ΔD/Δt of the degree of fatigue D, and the estimated remaining lifespan t′ can be used as an index of a failure risk, and, furthermore, an index acquired by combining these may also be generated.

In addition, in the above-described example, the pressure sensor 105 is installed in the water distribution block 104, and a pipe in the water distribution block 104 is to be diagnosed, but the present example embodiment is not limited to this example. In the present example embodiment, all of the pipes that make up a water pipe network such as the water main 101 are to be diagnosed.

### [Apparatus Operations]

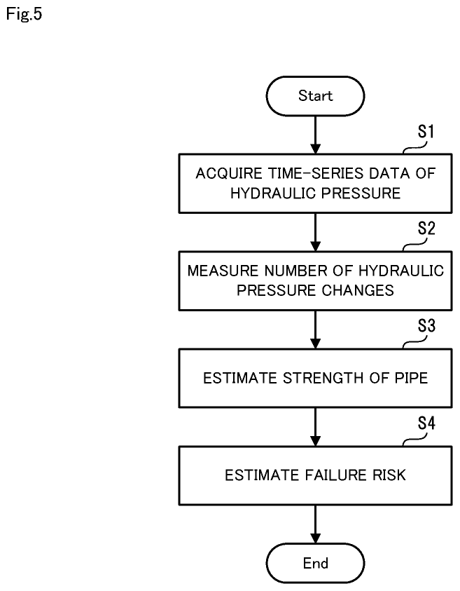

Next, operations of the pipe diagnosis apparatus 10 in the present example embodiment will be described with reference to FIG. 5. FIG. 5 is a flow chart illustrating operations of the pipe diagnosis apparatus in the example embodiment of the invention. The following description is given with reference to FIGS. 1 to 4 as appropriate. In addition, in the present example embodiment, a pipe diagnosis method is carried out by operating the pipe diagnosis apparatus 10. Thus, description of the pipe diagnosis method in the present example embodiment is substituted by the following description of operations of the pipe diagnosis apparatus 10.

As shown in FIG. 5, first, the time-series data acquisition unit 11 acquires time-series data on hydraulic pressure using data that is output by the pressure sensor 105 installed in a pipe that is included in the piping equipment 100 (step S1). The time-series data acquisition unit 11 also stores the acquired time-series data in the pressure database 16.

Next, the pressure change measurement unit 12 acquires, from the pressure database 16, the time-series data on the hydraulic pressure acquired in step S1, and measures, from the acquired time-series data on the hydraulic pressure, the number of hydraulic pressure changes for each portion of the water distribution block 104 (step S2).

Next, the pipe strength estimation unit 14 estimates the strength of the target pipe based on information stored in the pipe information database 17, and outputs an S-N curve of the pipe as estimated strength (step S3).

Next, the failure risk estimation unit 13 calculates an index indicating a failure risk for each pipe to be diagnosed, using the number of hydraulic pressure changes measured in step S2 and the S-N curve of the target pipe estimated in step S3 (step S4). In addition, the calculated index indicating a failure risk is transmitted to an administrator's terminal apparatus connected to the pipe diagnosis apparatus 10, and is displayed on the screen of the terminal apparatus. Accordingly, the administrator of the piping equipment 100 can determine appropriate replacement times and a replacement order of the pipe.

### SPECIFIC EXAMPLE

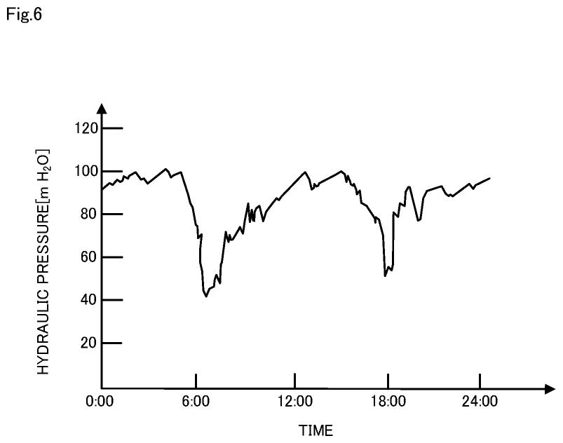

Subsequently, a specific example of the present example embodiment will be described with reference to FIG. 6. FIG. 6 is a diagram illustrating an example of time-series data on a hydraulic pressure at a point in a water distribution block. In the example in FIG. 6, measurement values of time-series data on hydraulic pressure for a day are shown, and, when water is not used, the hydraulic pressure at this point is 100 [mH₂O].

As shown in FIG. 6, when water is used, a pressure loss occurs when water is delivered to the point, and thus the hydraulic pressure decreases. In particularly, after six o'clock in the morning and at about six o'clock in the evening, the amount of water used by residents reaches a local maximum, and thus the hydraulic pressure falls close to 40 to 50 [mH₂O]. In addition, when a resident quickly opens/closes a faucet, water hammer occurs, and a large number of water hammer events occur particularly during the time period from six to ten o'clock,

Pressure changes that cause a pipe to fatigue include both changes ranging from 40 to 100 [mH₂O] over a day and the number of changes [mH₂O] due to water being used. By counting the number of hydraulic pressure changes using the rainflow counting method, and combining this number of hydraulic pressure changes with the S-N curve of the water pipe, it is possible to obtain the increase rate ΔD/Δt of the degree of fatigue per day. In addition, by multiplying the increase rate by the number of elapsed days obtained from the number of years Y that have elapsed since the pipe was installed, it is possible to obtain the degree of fatigue D at the present point in time, and it is also possible to obtain an estimated remaining lifespan t.

### [Asset Management Apparatus]

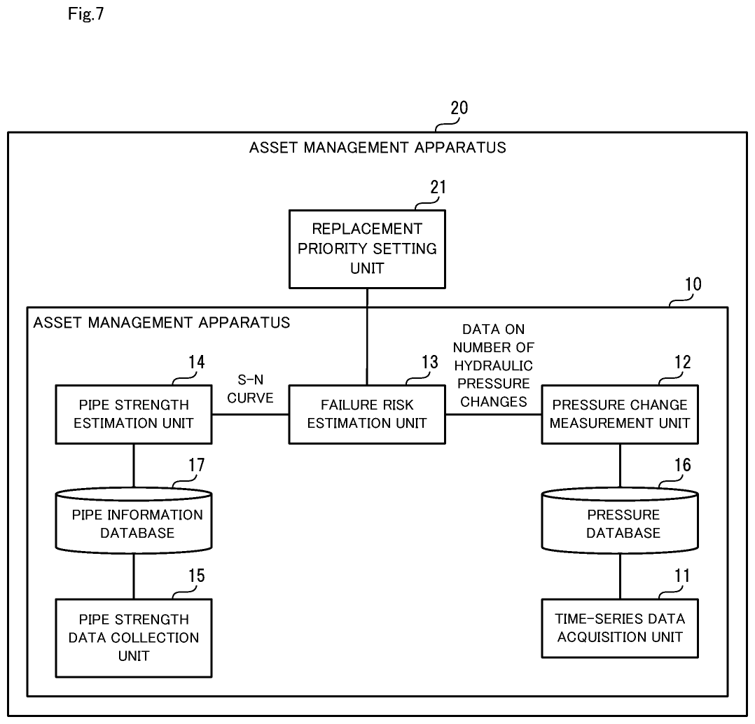

Subsequently, an asset management apparatus in the present example embodiment will be described with reference to FIG. 7. FIG. 7 is a block diagram illustrating the configuration of the asset management apparatus in the example embodiment of the invention.

As shown in FIG. 7, an asset management apparatus 20 in the present example embodiment is an apparatus for managing piping equipment owned by a business. As shown in FIG. 7, the asset management apparatus 20 is provided with the pipe diagnosis apparatus 10 shown in FIG. 2 and a replacement priority setting unit 21.

When the failure risk estimation unit 13 in the pipe diagnosis apparatus 10 estimates a failure risk, the replacement priority setting unit 21 sets a replacement priority for each of the pipes that are included in the piping equipment, based on the estimated failure risk. Specifically, the replacement priority setting unit 21 sets a replacement priority for each pipe based on an index calculated by the failure risk estimation unit 13. Note that the index used for this priority setting may be any index out of the above-described indexes.

In other words, the replacement priority setting unit 21 may use any of the degree of fatigue D, the increase rate ΔD/Δt of the degree of fatigue, and the estimated remaining lifespan t. For example, if the degree of fatigue D is used, the replacement priority setting unit 21 sets priorities in which a pipe with a higher degree of fatigue is ranked first. Accordingly, businesses can carry out replacement of pipes starting from a pipe with a high failure risk, and thus it is possible to perform efficient replacement for minimizing failures of pipes owned by the businesses.

### [Effect in Embodiment]

As described above, according to the present example embodiment, future progression of deterioration of a pipe is estimated. Therefore, it is possible to estimate the probability that a pipe will rupture, and, it is possible to further determine an appropriate replacement time and replacement order of the pipe. As a result, it is possible to efficiently suppress failure of piping equipment.

### [Program]

It suffices for a program in the present example embodiment to be a program that causes a computer to execute steps S1 to S4 shown in FIG. 5. By installing this program in a computer, and executing the program, it is possible to realize the pipe diagnosis apparatus 10 and the pipe diagnosis method in the present example embodiment. In this case, a processor of the computer functions as the time-series data acquisition unit 11, the pressure change measurement unit 12, the failure risk estimation unit 13, the pipe strength estimation unit 14, and the pipe strength data collection unit 15, and performs processing.

In addition, in the present example embodiment, the pressure database 16 and the pipe information database 17 can be realized by storing data files that make up these databases to a storage apparatus provided in a computer such as a hard disk, or mounting a recording medium that stores such data files to a reading apparatus connected to the computer.

In addition, the program in the present example embodiment may also be executed by a computer system constituted by a plurality of computers. In this case, for example, a configuration may also be adopted in which each of the computers functions as one of the time-series data acquisition unit 11, the pressure change measurement unit 12, the failure risk estimation unit 13, the pipe strength estimation unit 14, and the pipe strength data collection unit 15. In addition, the pressure database 16 and the pipe information database 17 may also be constructed on a computer other than the computer that executes the program in the present example embodiment.

### [Physical Configuration]

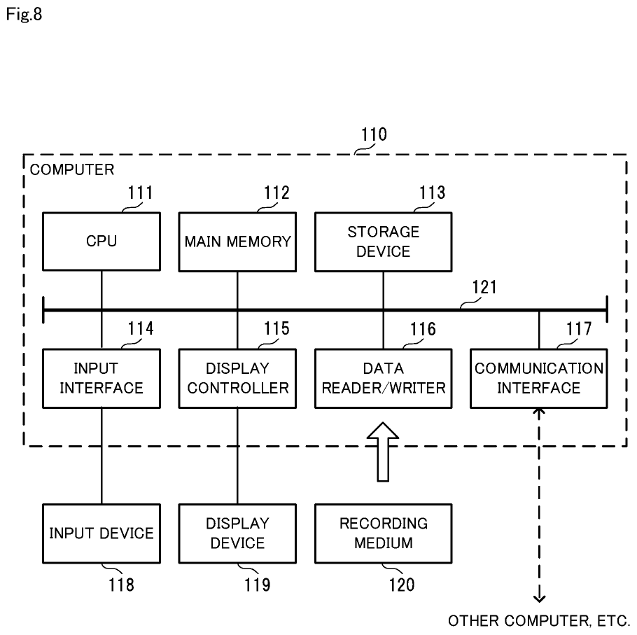

Here, a computer that realizes the pipe diagnosis apparatus 10 by executing the program in the present example embodiment will be described with reference to FIG. 8. FIG. 8 is a block diagram illustrating an example of a computer that realizes the pipe diagnosis apparatus in the example embodiment of the invention. In addition, in the present example embodiment, the asset management apparatus 20 can also be realized by the computer shown in FIG. 8.

As shown in FIG. 8, a computer 110 is provided with a CPU (Central Processing Unit) 111, a main memory 112, a storage apparatus 113, an input interface 114, a display controller 115, a data reader/writer 116, and a communication interface 117. These units are connected via a bus 121 to allow mutual data communication. Note that the computer 110 may also be provided with a GPU (Graphics Processing Unit) or an FPGA (Field-Programmable Gate Array) in addition to the CPU 111, or in place of the CPU 111.

The CPU 111 carries out various calculations by deploying programs (codes) in the present example embodiment stored in the storage apparatus 113 to the main memory 112, and executing these in a predetermined order. The main memory 112 is typically a volatile storage apparatus such as a DRAM (Dynamic Random Access Memory). In addition, the programs in the present example embodiment are provided in a state of being stored in a computer-readable recording medium 120. Note that the programs in the present example embodiment may also be programs distributed on the Internet connected via the communication interface 117.

In addition, specific examples of the storage apparatus 113 include a semiconductor storage apparatus such as a flash memory, in addition to a hard disk drive. The input interface 114 mediates data transmission between the CPU 111 and an input device 118 such as a keyboard or a mouse. The display controller 115 is connected to a display apparatus 119, and controls display on the display apparatus 119.

The data reader/writer 116 mediates data transmission between the CPU 111 and the recording medium 120, reads out a program from the recording medium 120, and writes a processing result from the computer 110 to the recording medium 120. The communication interface 117 mediates data transmission between the CPU 111 and another computer.

In addition, specific examples of the recording medium 120 include general-purpose semiconductor storage devices such as a CF (Compact Flash (registered trademark)) and an SD (Secure Digital), magnetic recording media such as a flexible disk, and optical recording media such as a CD-ROM (Compact Disk Read Only Memory).

Note that the pipe diagnosis apparatus 10 in the present example embodiment can also be realized by using hardware items corresponding to the units instead of a computer in which the programs are installed. Furthermore, a configuration may also be adopted in which a portion of the pipe diagnosis apparatus 10 is realized by a program, and the remaining portion is realized by hardware.

A portion or the entirety of the above example embodiment can be expressed as Supplementary notes 1 to 22 to be described below, but there is no limitation to the following description.

(Supplementary Note 1)

A pipe diagnosis apparatus comprising:

a time-series data acquisition unit configured to acquire time-series data on pressure of a fluid in piping equipment to be diagnosed;

a pressure change measurement unit configured to measure the number of pressure changes in the fluid from the time-series data on the pressure of the fluid; and

a failure risk estimation unit configured to estimate a failure risk of the piping equipment based on the measured number of pressure changes and a strength of a pipe included in the piping equipment.

(Supplementary Note 2)

The pipe diagnosis apparatus according to Supplementary note 1,

wherein the time-series data acquisition unit acquires the time-series data using data that is output by a pressure sensor installed in a pipe included in the piping equipment.

(Supplementary Note 3)

The pipe diagnosis apparatus according to Supplementary note 1 or 2,

wherein the time-series data acquisition unit acquires, as the time-series data, pressure estimated using a hydraulic simulator, regarding all or some pipes included in the piping equipment.

(Supplementary Note 4)

The pipe diagnosis apparatus according to any one of Supplementary notes 1 to 3,

wherein the failure risk estimation unit calculates, as the failure risk, an index whose value increases as the number of pressure changes increases.

(Supplementary Note 5)

The pipe diagnosis apparatus according to any one of Supplementary notes 1 to 3,

wherein the failure risk estimation unit calculates, as the failure risk, an index whose value increases as an amplitude of the pressure change increases.

(Supplementary Note 6)

The pipe diagnosis apparatus according to any one of Supplementary notes 1 to 5, further comprising:

a pipe strength estimation unit configured to estimate a strength of a pipe included in the piping equipment.

(Supplementary Note 7)

The pipe diagnosis apparatus according to Supplementary note 6,

wherein the pipe strength estimation unit estimates a strength of a pipe included in the piping equipment, using at least the number of years elapsed from when the pipe included in the piping equipment was laid.

(Supplementary Note 8)

An asset management apparatus comprising:

a time-series data acquisition unit configured to acquire time-series data on pressure of a fluid in piping equipment to be diagnosed;

a pressure change measurement unit configured to measure the number of pressure changes in the fluid from the time-series data on the pressure of the fluid;

a failure risk estimation unit configured to estimate a failure risk of the piping equipment based on the measured number of pressure changes and a strength of a pipe included in the piping equipment; and

a replacement priority setting unit configured to set a replacement priority of each pipe included in the piping equipment, based on the failure risk estimated by the failure risk estimation unit.

(Supplementary Note 9)

A pipe diagnosis method comprising:

(a) a step of acquiring time-series data on pressure of a fluid in piping equipment to be diagnosed;

(b) a step of measuring the number of pressure changes in the fluid from the time-series data on the pressure of the fluid; and

(c) a step of estimating a failure risk of the piping equipment based on the measured number of pressure changes and a strength of a pipe included in the piping equipment.

(Supplementary Note 10)

The pipe diagnosis method according to Supplementary note 9,

wherein, in the (a) step, the time-series data is acquired using data that is output by a pressure sensor installed in a pipe included in the piping equipment.

(Supplementary Note 11)

The pipe diagnosis method according to Supplementary note 9 or 10,

wherein, in the (a) step, pressure estimated using a hydraulic simulator is acquired as the time-series data, regarding all or some pipes included in the piping equipment.

(Supplementary Note 12) The pipe diagnosis method according to any one of Supplementary notes 9 to 11,

wherein, in the (c) step, an index whose value increases as the number of pressure changes increases is calculated as the failure risk.

(Supplementary Note 13)

The pipe diagnosis method according to any one of Supplementary notes 9 to 11,

wherein, in the (c) step, an index whose value increases as an amplitude of the pressure change increases is calculated as the failure risk.

(Supplementary Note 14)

The pipe diagnosis method according to any one of Supplementary notes 9 to 13, further comprising:

(d) a step of estimating a strength of a pipe included in the piping equipment.

(Supplementary Note 15)

The pipe diagnosis method according to Supplementary note 14,

wherein, in the (d) step, a strength of a pipe included in the piping equipment is estimated using at least the number of years elapsed from when the pipe included in the piping equipment was laid.

(Supplementary Note 16)

A computer-readable recording medium that stores a program that contains instructions for causing a computer to execute:

(a) a step of acquiring time-series data on pressure of a fluid in piping equipment to be diagnosed;

(b) a step of measuring the number of pressure changes in the fluid from the time-series data on the pressure of the fluid; and

(c) a step of estimating a failure risk of the piping equipment based on the measured number of pressure changes and a strength of a pipe included in the piping equipment.

(Supplementary Note 17)

The computer-readable recording medium according to Supplementary note 16,

wherein, in the (a) step, the time-series data is acquired using data that is output by a pressure sensor installed in a pipe included in the piping equipment.

(Supplementary Note 18)

The computer-readable recording medium according to Supplementary note 16 or 17,

wherein, in the (a) step, pressure estimated using a hydraulic simulator is acquired as the time-series data, regarding all or some pipe included in the piping equipment.

(Supplementary Note 19)

The computer-readable recording medium according to any one of Supplementary notes 16 to 18,

wherein, in the (c) step, an index whose value increases as the number of pressure changes increases is calculated as the failure risk.

(Supplementary Note 20)

The computer-readable recording medium according to any one of Supplementary notes 16 to 18,

wherein, in the (c) step, an index whose value increases as an amplitude of the pressure change increases is calculated as the failure risk.

(Supplementary Note 21)

The computer-readable recording medium according to any one of Supplementary notes 16 to 20,

wherein the program causes the computer to execute

(d) a step of estimating a strength of a pipe included in the piping equipment.

(Supplementary Note 22)

The computer-readable recording medium according to Supplementary note 21,

wherein, in the (d) step, a strength of a pipe included in the piping equipment is estimated using at least the number of years elapsed from when the pipe included in the piping equipment was laid.

Although the present invention has been described above with reference to the example embodiment above, the invention is not limited to the above example embodiment. Various modifications understandable to a person skilled in the art can be made in configurations and details of the invention, within the scope of the invention.

This application is based upon and claims the benefit of priority from Japanese Patent Application No 2017-062649, filed Mar. 28, 2017, the disclosure of which is incorporated herein in its entirety by reference.

### INDUSTRIAL APPLICABILITY

As described above, according to the invention, it is possible to estimate future progression of deterioration of a pipe in piping equipment. The present invention is useful for applications in, for example, a system for distributing fluid using a pipe network, such as a pipe network system for delivering clean water from a water purification plant and pipelines for supplying oil and gas.

### LIST OF REFERENCE SIGNS

10 Pipe diagnosis apparatus
11 Time-series data acquisition unit
12 Pressure change measurement unit
13 Failure risk estimation unit
14 Pipe strength estimation unit
15 Pipe strength data collection unit
16 Pressure database
17 Pipe information database
20 Asset management apparatus
21 Replacement priority setting unit
100 Piping equipment
101 Water main
102 Pump
103 Pressure reducing valve
104 Water distribution block
105 Pressure sensor
106 Water purification plant
110 Computer
111 CPU
112 Main memory
113 Storage apparatus
114 Input interface
115 Display controller
116 Data reader/writer
117 Communication interface
118 Input device
119 Display apparatus
120 Recording medium
121 Bus

What is claimed is:

1. A pipe diagnosis apparatus comprising:
a time-series data acquisition unit configured to acquire time-series data on pressure of a fluid in piping equipment to be diagnosed;
a pressure change measurement unit configured to measure the number of pressure changes in the fluid from the time-series data on the pressure of the fluid; and
a failure risk estimation unit configured to estimate a failure risk of the piping equipment based on the measured number of pressure changes and a strength of a pipe included in the piping equipment.

2. The pipe diagnosis apparatus according to claim 1,
wherein the time-series data acquisition unit acquires the time-series data using data that is output by a pressure sensor installed in a pipe included in the piping equipment.

3. The pipe diagnosis apparatus according to claim 1,
wherein the time-series data acquisition unit acquires, as the time-series data, pressure estimated using a hydraulic simulator, regarding all or some pipes included in the piping equipment.

4. The pipe diagnosis apparatus according to claim 1,
wherein the failure risk estimation unit calculates, as the failure risk, an index whose value increases as the number of pressure changes increases.

5. The pipe diagnosis apparatus according to claim 1,
wherein the failure risk estimation unit calculates, as the failure risk, an index whose value increases as an amplitude of the pressure change increases.

6. The pipe diagnosis apparatus according to claim 1, further comprising:
a pipe strength estimation unit configured to estimate a strength of a pipe included in the piping equipment.

7. The pipe diagnosis apparatus according to claim 6,
wherein the pipe strength estimation unit estimates a strength of a pipe included in the piping equipment, using at least the number of years elapsed from when the pipe included in the piping equipment was laid.

8. (canceled)

9. A pipe diagnosis method comprising:
(a) acquiring time-series data on pressure of a fluid in piping equipment to be diagnosed;
(b) measuring the number of pressure changes in the fluid from the time-series data on the pressure of the fluid; and
(c) estimating a failure risk of the piping equipment based on the measured number of pressure changes and a strength of a pipe included in the piping equipment.

10. A non-transitory computer-readable recording medium that stores a program that contains instructions for causing a computer to execute:
(a) a step of acquiring time-series data on pressure of a fluid in piping equipment to be diagnosed;
(b) a step of measuring the number of pressure changes in the fluid from the time-series data on the pressure of the fluid; and
(c) a step of estimating a failure risk of the piping equipment based on the measured number of pressure changes and a strength of a pipe included in the piping equipment.

11. The pipe diagnosis method according to claim 9,
wherein, in the (a), the time-series data is acquired using data that is output by a pressure sensor installed in a pipe included in the piping equipment.

12. The pipe diagnosis method according to claim 9,
wherein, in the (a), pressure estimated using a hydraulic simulator is acquired as the time-series data, regarding all or some pipes included in the piping equipment.

13. The pipe diagnosis method according to claim 9,
wherein, in the (c), an index whose value increases as the number of pressure changes increases is calculated as the failure risk.

14. The pipe diagnosis method according to claim 9,
wherein, in the (c), an index whose value increases as an amplitude of the pressure change increases is calculated as the failure risk.

15. The pipe diagnosis method according to claim 9, further comprising:
(d) estimating a strength of a pipe included in the piping equipment.

16. The pipe diagnosis method according to claim 14,
wherein, in the (d), a strength of a pipe included in the piping equipment is estimated using at least the number of years elapsed from when the pipe included in the piping equipment was laid.

17. The non-transitory computer-readable recording medium according to claim 10,
wherein, in the (a) step, the time-series data is acquired using data that is output by a pressure sensor installed in a pipe included in the piping equipment.

18. The non-transitory computer-readable recording medium according to claim 10,
wherein, in the (a) step, pressure estimated using a hydraulic simulator is acquired as the time-series data, regarding all or some pipe included in the piping equipment.

19. The non-transitory computer-readable recording medium according to claim 10,
wherein, in the (c) step, an index whose value increases as the number of pressure changes increases is calculated as the failure risk.

20. The non-transitory computer-readable recording medium according to claim 10,
wherein, in the (c) step, an index whose value increases as an amplitude of the pressure change increases is calculated as the failure risk.
